(19) United States
(12) Patent Application Publication
(10) Pub. No.: US 2007/0027700 A1
(43) Pub. Date: Feb. 1, 2007

(54) SYSTEM AND METHOD FOR GLOBAL INFORMAITON DELIVERY MANAGEMENT THROUGH A REPORTING HIEARACHY

(76) Inventors: Sivajini Ahamparam, Scottsdale, AZ (US); David R. Babcock, Phoenix, AZ (US); Heidi M. Felan, Peoria, AZ (US); Marc James Klemp, Phoenix, AZ (US); Andrew Paul Nicholls, Kingwood, TX (US); Neeraj Sharma, Phoenix, AZ (US); Orville A. Williams, Glendale, AZ (US); Catherine M. Zorne, Peoria, AZ (US)

Correspondence Address: SNELL & WILMER, 400 EAST VAN BUREN, ONE ARIZONA CENTER, PHOENIX, AZ, 85004-2202, US

(21) Appl. No.: 11/161,323

(22) Filed: Jul. 29, 2005

(51) Int. Cl. G06Q 99/00; G07G 1/00; G06F 17/30

(52) U.S. Cl. 705/1; 705/10

(57) ABSTRACT

The invention includes a system and method for defining a reporting hierarchy by linking multiple systems and databases within a single web process. The system provides a web interface where reporting organizations, groups and entities can be defined as well as interfaces for managing report recipients and configuration of report delivery options.

### FIELD OF INVENTION

The invention generally relates to the creation and maintenance of reporting hierarchies within an enterprise, and more particularly, to a system and method for effectively and efficiently integrating data from a plurality of data sources within a single web service in order to better target data recipients throughout the enterprise.

### BACKGROUND OF INVENTION

Large product or service based corporations have typically relied upon reports to understand historical trends, determine fiscal health and predict future revenues and debts. The information in the reports is often useful in helping decision makers plan business activities across all operations. Enterprises usually develop and distribute large numbers of reports on activities that range from sales data to product inventories.

For global enterprises that store similar types of information in different databases or computing systems, reporting becomes far more complex. For example, a global financial services company may control sales and customer support offices in a number of different countries, wherein the various offices are often grouped by region which may include United States, Europe and Asia. The company often finds a need to create corporate sales reports, while maintaining the ability to report by region and country. Further, while the same financial services company may be represented in a variety of countries, there will likely be differences in product offerings due to variances in governmental regulations and currencies. Therefore, it may not be feasible to store data holistically due to a number of variances.

Despite the data storage variances of a global enterprise, a need continues to exist for not only reports by region or country, but by various other factors. For example, a sales manager for a European region may be primarily concerned with sales reports reflecting sales activity in Europe, however there may also be a need to view reports on sales activities in other regions and countries. Further, it would be desirable for the sales manager to not only receive reports based on a combination of regions, but also from a sub-combination comprising any number of regions in combination with countries.

Therefore, a need exists for a system and method for interlinking a plurality of data sources through a single web service in order to create reporting tiers wherein descending tiers define report recipients with greater specificity. Such a reporting hierarchy would enable enterprises to more effectively target reports to the most relevant individuals.

### SUMMARY OF INVENTION

The invention provides an acquiring tier within a computing infrastructure, wherein data from a plurality of sources is combined according to the business needs of the user. The system of the invention enables a global enterprise to use a single system to setup a plurality of disparate systems for reporting as opposed to requiring each independent region of the enterprise to configure each system individually. Through a series of user interface elements, a user can identify, configure and maintain reporting organizations, reporting groups and reporting entities. Further, a user can add and/or modify report recipients and configure report options. The elements used to construct the reporting hierarchy may be obtained through any number of databases, applications and computing systems which are combined through a single web service for that purpose.

Specifically, the acquiring tier provides a central interface to allow delivery of products to internal and external users through third-party tools such as, for example, Ab Initio®, MicroStrategy®, Information Builders® and the like. The acquiring tier acknowledges requests by transforming the information into the various third-part tools via parameters and messages for delivery to users

A user can create reporting organizations which represent a broad crosssection of report recipients. Within a reporting organization, a user can define a plurality of reporting groups. Reporting groups narrow the list of report recipients by segmenting a reporting organization. Two or more reporting groups may be linked, thereby creating entities representing an even tighter concentration of report recipients. At the base of the reporting hierarchy are individual report recipients. Therefore, a group of recipients may represent an entity and an entity may represent a number of reporting groups. A reporting organization also represents a number of reporting groups, however it is differentiated from an entity in that a reporting group may belong to a single reporting organization while being associated with any number of entities.

Further, the system enables users to manage report recipients by assigning them to reporting groups. Also, a user can interact with the system to configure report preferences. Such preferences include, for example, report delivery frequency, report format, sort criteria, delivery method and the like.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is a block diagram illustrating the major system components for an exemplary system for configuring and maintaining hierarchy based reporting; and

FIGS. 2A-2C is a flowchart illustrating an exemplary process for interacting with the invention through a user interface according to one embodiment of the invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

In general, the invention includes a system and method for consolidating data from multiple computing systems and databases within a single web process to provide a centralized information access point for users. The invention facilitates the creation of reporting organizations, groups and entities for which varying data views from a plurality of computing systems and databases will be exposed.

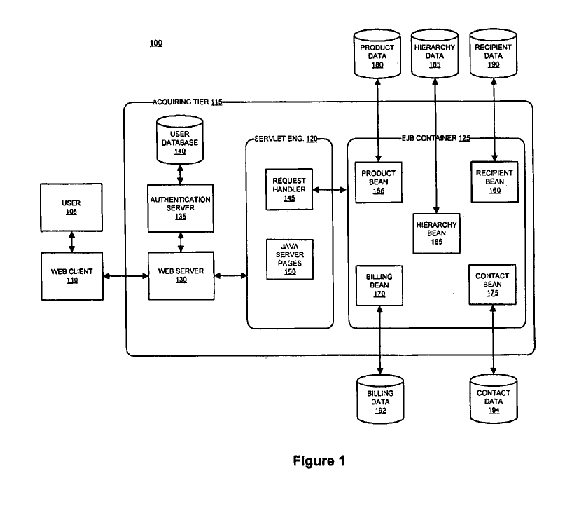

With reference to FIG. 1, system 100 facilitates interaction between user 105 and acquiring tier 115 through a web client 110. Web client 110 is connected to a web server 130 through a network connection (e.g., Internet, Intranet, LAN, WAN). In one embodiment, web server 130 employs an authentication server 135 in order to validate and assign proper permissions to authorized users of the system. User database 140 stores user credentials and permissions specific to each user. Web server 130 further interacts with a servlet engine 120. A servlet engine 120 is an applications server for executing Java code at the server rather than at the web client 110. Servlet engine 120 is known in the art and may include a commercial product such as, for example, IBM WebSphere, Oracle Applications Server, BEA Weblogic and the like. Servlet engine 120 facilitates the creation of HTML documents from Java Server Pages (JSP) 150 and further includes a number of request handlers 145 for receiving requests from web client 110 and processing the requests by invoking an Enterprise Java Bean (EJB) container 125.

EJB container 125 specifies a runtime environment for enterprise Java beans that includes, for example, security, concurrency, life cycle management, transactions, deployment, naming, and other services. EJB container 125 includes any number of EJBs which are Java code components that are similar to other types of code components, only they are written in the Java programming language and can be run on any operating system provided Java Virtual Machine is present. In the context of FIG. 1, the exemplary EJBs are represented by product bean 155, recipient bean 160, hierarchy bean 165, billing bean 170 and contact bean 175. The beans are code components configured to perform data transactions within varying data sources. As each data source may be different (e.g. SQL Server, Oracle DBMS, IMS, etc.), each source bean contains the parameters unique to each data source in order to effectively communicate with each data source.

Data sources consist of, for example, databases, files, applications or any other computing memory structure capable of storing data. In one embodiment, product database 180 includes a SQL Server database for which the product bean 155 contains the necessary constructs to establish a connection, extract data, and update data. Likewise, hierarchy database 185, recipient database 190, billing database 192 and contact database 194 each represent specialized data that may or may not reside in like storage configurations. Further, where it is necessary or desirable to access data through another application or component, beans are configured to interact with applications, in order to retrieve and/or manipulate data.

Practitioners will appreciate that while FIG. 1 shows a java-based configuration of the system 100, other architectures may be employed with similar results. In addition to the components discussed above, in one embodiment, system 100 further includes one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the invention.

User 105 includes any individual, business, entity, government organization, software and/or hardware which interact with system 100 to define reporting organizations, groups and entities in order to target reporting data to the appropriate recipients on a global scale. User 105 may include an administrator, for example, as well as any other individual given authority to define and/or modify report distribution. User 105 interacts with an acquiring tier 115 of system 100 through a web client 110 via any communication protocol, device or method discussed herein or known in the art. In one embodiment, user 105 interacts with acquiring tier 115 via an Internet browser at web client 105.

Web client 110 comprises any hardware and/or software suitably configured to facilitate input, receipt and/or review of report and group configurations as well as view information and/or reports as provided by acquiring tier 115 or any information discussed herein. Web client 110 includes any device (e.g., personal computer) which communicates (in any manner discussed herein) with acquiring tier 115 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, minicomputers, PC servers, pervasive computers, network sets of computers, and/or the like. Practitioners will appreciate that web client 110 may or may not be in direct contact with system 100. For example, web client 110 may access the services of system 100 through another server, which may have a direct or indirect connection to web server 130.

As those skilled in the art will appreciate, web client 110 includes an operating system (e.g., Windows NT, 95/98/2000, OS2, UNIX, Linux, Solaris, MacOS, etc.) as well as various conventional support software and drivers typically associated with computers. The web client 110 may include any suitable personal computer, network computer, workstation, minicomputer, mainframe or the like. Web client 110 can be in a home or business environment with access to a network. In an exemplary embodiment, access is through a network or the Internet through a commercially available web-browser software package.

Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

The invention contemplates uses in association with web services, utility computing, pervasive and individualized computing, security and identity solutions, autonomic computing, commodity computing, mobility and wireless solutions, open source, biometrics, grid computing and/or mesh computing.

Web server 130 may include any hardware and/or software suitably configured to facilitate communications between web client 110 and one or more system 100 components. Further, web server 130 may be configured to transmit data to web client 110 within markup language documents. Web server 130 may operate as a single entity in a single geographic location or as separate computing components located together or in separate geographic locations. While not shown if FIG. 1, requests originating from web client 110 may pass through a firewall before being received and processed at web server 130. As used herein, “transmit” may include sending electronic data from one system component to another over a network connection. Additionally, as used herein, “data” may include encompassing information such as commands, queries, files, data for storage, and the like in digital or any other form.

Web server 130 may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Servlet engine 120 may include any hardware and/or software suitably configured to receive and process requests originating from web client 110 and/or web server 130. Servlet engine 120 may communicate with any number of other servers, databases and/or components through any means known in the art. Further, servlet engine 120 may serve as a conduit between web server 130 and any number of systems and components of acquiring tier 115. Web server 130 may interface with servlet engine 120 through any means known in the art including a LAN/WAN, for example. Further, servlet engine 120 may reside within a memory structure of web server 130 or within another standalone server and may be implemented as a commercial product, a custom product or a combination thereof.

While not shown, acquiring tier 115 may further include a report engine. Report engine includes any hardware and/or software suitably configured to produce reports from information stored in one or more databases. Report engines are commercially available and known in the art. Report engine provides, for example, printed reports, web access to reports, graphs, real-time information, raw data, batch information and/or the like. Report engine may be implemented through commercially available hardware and/or software, through custom hardware and/or software components, or through a combination thereof. Further, report engine may reside as a standalone system within acquiring tier 115 or as a component of web server 130.

In order to control access to web server 130 or any other component of acquiring tier 115, web server 130 invokes an authentication server 135 in response to submission of user 105 authentication credentials received at web server 130. Authentication server 135 includes any hardware and/or software suitably configured to receive authentication credentials, encrypt and decrypt credentials, authenticate credentials, and grant access rights according to user 105 pre-defined privileges attached to the credentials. Authentication server 135 grants varying degrees of application and data level access to user 105 based on user information stored within user database 140.

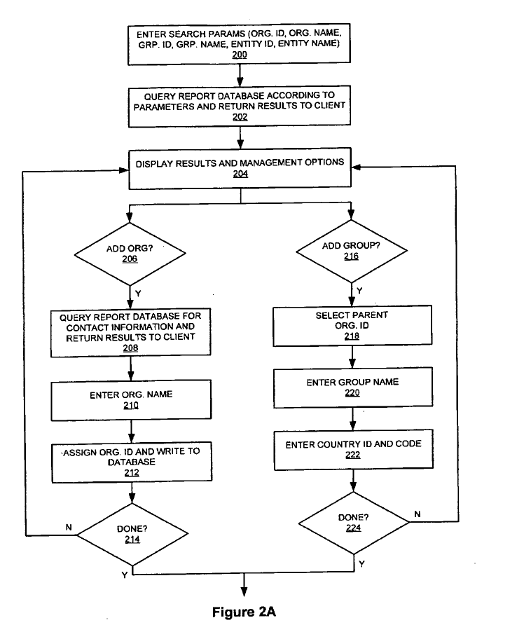

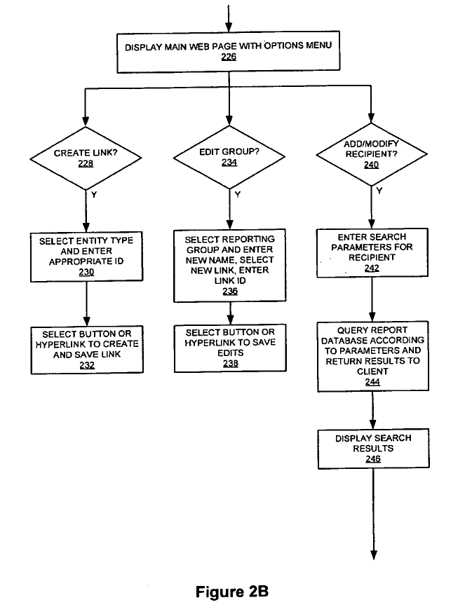

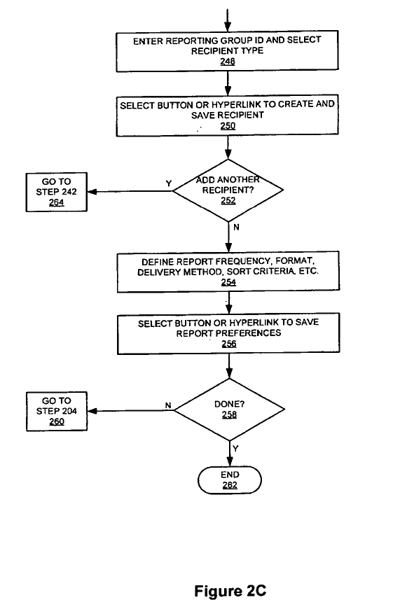

Referring now to FIGS. 2A-2C, the process flows depicted are merely embodiments and are not intended to limit the scope of the invention as described herein. For example, the steps recited in any of the method or process descriptions may be executed in any order and are not limited to the order presented. It will be appreciated that the following description makes appropriate references not only to the steps depicted in FIGS. 2A-2C, but also to the various system components as described above with reference to FIG. 1.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The flowcharts of FIGS. 2A - 2C illustrate an exemplary process for interacting with system 100 through a user interface. System 100 may implement known methods for preventing access from unauthorized users such as requiring users to register and/or by assigning authentication credentials to individual users. However, system 100 anticipates an authentication server 135 which is employed to enforce security policies by allowing varying levels of access to users 105 based on such policies. Internet security protocols including methods of authentication and user management are well known in the art, therefore system 100 may employ any number of security architectures. An authentication process will not be described a greater detail herein.

In another embodiment, system 100 enables user 105 to enter a single set of authentication credentials to create a web session. Thereafter, user 105 is not required to re-enter credentials while accessing data from different systems, wherein each system may require authentication. For as long as the web session remains active, user 105 is not required to re-enter authentication credentials for each secure system accessed. For example, user 105 may be required to enter authentication credentials on entering a reporting web site. These credentials may be used repeatedly to access appropriate credentials from a key master when accessing data from a secure source. The key master contains a set of authentication credentials that may be transparently entered when required.

As used herein, a request for data may follow a similar logical flow through the various components of the acquiring tier 115. A request for data originating at web client 110 is transmitted via a network to web server 130. Web server 130 performs any necessary formatting of the request prior to sending it to servlet engine 120. A request handler 145 of the servlet engine receives the request and routes it to the appropriate bean within an EJB container 125. The bean constructs a query according to the supplied parameters and invokes the query against the appropriate database. Resulting records are returned to the servlet engine 120 where they are integrated within a JSP 150. The JSP 150 is converted to HTML and streamed across a network to web client 110 which constructs the web page and displays it within a browser application.

As used herein, the steps of saving data to a database may follow a similar, but reverse, flow as described above. Data transmitted from web client 110 is routed through web server 130 to a servlet engine's request handler 145. Request handler 145 routes the data to the appropriate bean where it is determined what type of transaction is to be executed (e.g. add record, update record, delete record). The bean formats the data within a, for example, SQL statement that is invoked against the appropriate database.

Those skilled in the art will appreciate that the steps described above relating to requesting and saving data are not all inclusive, rather, the steps are presented for the sake of explanation. Further, the invention contemplates different methods and architectures for interacting with databases and those described herein do not limit the scope of the invention.

Upon receiving proper authentication, user 105 is presented with a search web page providing fields for entering search credentials (step 200). Search credentials may include, for example, organization ID, organization name, reporting group ID, reporting group name, entity ID, entity name, etc. Therefore, if user 105 would like to view a specific reporting group, user 105 may enter the group ID into the appropriate field. On selecting a link to invoke the search process, a request is transmitted to acquiring tier 115 and results are transmitted to web client (step 202). Search results are displayed within a management options web page (step 204) that further includes a number of links to enable user 105 to perform additional management functions (step 204). Varying management options enable an administrator to define and/or maintain, for example, reporting organizations, reporting groups, reporting entities, associations (or links), and report delivery options.

User 105 may add reporting organizations (step 206) and add reporting groups (step 216) by selecting the respective web page link. A reporting organization may contain any number of reporting groups. For example, a user may create a “Corporation A” reporting organization. The “Corporation A” organization may further include “Accounting” and “Legal” reporting groups. Upon selecting to add a reporting organization (step 206), a request for data is transmitted to the acquiring tier 115 and routed to the contact database 194. Resulting contact data is displayed within a web page (step 208). The web page provides a field where user 105 may enter a name for the new organization (step 210). When user 105 selects a link to add the new organization, the data is received at acquiring tier 115 and routed to hierarchy bean 165. Hierarchy bean 165 formats the data and stores it within hierarchy database (step 212). If user 105 has additional organizations to add (step 214), then user 105 is again presented with a display of results and management options (step 204).

User 105 may also add new reporting groups (step 216). On selecting a link to add a new group, a request for data is transmitted to acquiring tier 115 where it is received at hierarchy bean 165. Hierarchy bean 165 retrieves organization data from hierarchy database 185 resulting in a list of organizations that were previously added. The list of organizations is transmitted to web client 100 and user 105 is prompted to select a parent organization ID for the new reporting group (step 218), thereby defining the relationship between the reporting group and the reporting organization. The interface further includes a field for user 105 to enter a name for the reporting group (step 220). User 105 may further enter a country code ID and country code for the reporting group (step 222). For example, it is not uncommon for large international corporations to spread operations across a number of countries. For example, a large electronics corporation may have sales offices in the United States as well as in various countries in Europe and Asia. Therefore, it is often desirable or even necessary to create two or more reporting levels, wherein a first level may include the sales offices of Great Brittan; a second level may include sales offices of all European countries, while a third holistic level may include all worldwide sales offices. Therefore, the system 100 enables reporting groups to be further defined by geographical region.

When user 105 has finished defining a new reporting group, information pertaining to the new group is transmitted to acquiring tier 115, received by hierarchy bean 165, and saved to hierarchy database 185. If user would like to add additional reporting groups (step 224), then user 105 is again presented with a display of results and management options (step 204), wherein the aforementioned steps are repeated.

From a main web page providing further management options (step 226), user 105 is provided access to create a link (step 228), edit a reporting group (step 234) and add a recipient (step 340). For simplicity, the web page shown in step 226 of FIG. 2B is separate from that of step 204 of FIG. 2A; however practitioners will appreciate that both web pages could be combined into a single management web page.

To provide targeted reports to the appropriate members of an enterprise, system 100 enables user 105 to define entities. Entities are reporting groups that are linked according to overlapping reporting needs. For example, in the context of product customers, an entity may comprise any number of groups that require such information, which may include Sales and Customer Service. If user 105 desires to create a new link (step 228), user 105 may select a button and/or hyperlink to open a new web page or window. User 105 may then select an entity type and enter an appropriate ID (step 230). As previously described, varying reporting levels may be defined within parent-child relationships (e.g., reporting organizations or reporting groups). Links may further serve to target specific information needs within an organization by allowing a user 105 to link organizations and groups on a number of additional data identifiers such as, for example, business unit ID, control account ID, client ID, product ID, etc.

When a new link has been defined, user 100 may select a button and/or hyperlink to transmit link information to acquiring tier 115 where it is routed to hierarchy bean 165. Hierarchy bean formats the data and transmits it to hierarchy database 185 to be stored (step 232). Thereafter, reports may be targeted to the entity which comprises the linked reporting groups

From time to time, a need may arise where modification to one or more reporting groups is necessary or desirable. To edit an existing reporting group (step 234), user 105 invokes a search of hierarchy database 185 based on a group ID and/or group name as previously described. Attributes defining the group are returned to web client 110 and user 105 may select an “Edit” link to access a web page displaying group attributes with editable fields. Those skilled in the art will appreciate that an administrator may determine which attributes may be modified. For example, user 105 may be allowed to edit the reporting group name, entity type and entity ID. However, in order to maintain parent-child relationships, user 105 may be prohibited from editing the group ID and organization ID. User 105 may enter a new name for the group and/or modify or add a link type along with a link ID identifying the reporting group to link to (step 236). When edits are complete, user 105 selects a link to transmit the data to the acquiring tier 115 where it received by the hierarchy bean and stored within hierarchy database 185 (step 238).

While not illustrated, those skilled in the art will appreciate that modifications may be made to one or more reporting organizations in a manner similar to that described above in reference to modifying a reporting group.

From the main web page which includes management options menus and/or links (step 226), user 105 accesses functionality to add a report recipient to a reporting group (step 240). User 105 initiates a search for recipient by entering search parameters into a search web page (step 242). Search parameters may include, for example, recipient ID, first name, last name, employee ID, email address, etc. Selecting a “search” link transmits the parameters within a request to acquiring tier 115 where it is routed to the contact bean 175. Contact bean 175 queries the contact database 194 and the results are transmitted to web client 110 (step 244).

Web client 110 displays results within a table showing the contact's attributes (step 246). If more than one contact is returned to web client 110, then user 105 may select the desired contact to add as a report recipient who may be internal or external to the enterprise. On selecting a contact, user 105 enters a reporting group ID and selects a recipient type from a dropdown menu (step 248). Recipients may be classified as, for example, “SLS =Sales”, “OPS =Operations”, “CLT =Client”, “MOU =Multiple” and “OTH =Other”, etc. The reporting group ID is the group that the recipient will be added to in order to receive reports pertaining to the group. The recipient type controls the level of access the recipient will have to client data. When the new recipient has been defined, user 105 selects a link to save the new recipient to the appropriate databases (step 250). In this case, the transmission of recipient data is routed to the recipient bean 160 which adds the new recipient to the recipient database 190. If user 105 desires to add additional recipients (step 252), user 105 may select a link to return to a search page to enter search parameters (step 264).

User 105 may also configure report properties. In one embodiment, report properties define when a report is delivered, how it is delivered, the format of the report, sorting criteria and the like. On selecting from a list of reports, user 105 is presented a web page where report properties may be defined. The web page includes fields and dropdown menus where user 105 can set values such as, for example, entering a reporting group id for a group to receive the report, report delivery frequency, format, delivery method, hold indicator, sort criteria, etc. When user 105 has completed setting up the report, a hyperlink invokes transmission of the set-up data to the acquiring tier 115 (step 256). Product bean 155 formats the data and adds a record to product database (step 180).

Step 262 represents the end block where user 105 completes interaction with system 100 to define and/or maintain reporting organizations, reporting groups, entities, recipients and reports. If user 105 desires to perform additional activities within system 100 (step 258), then user 105 may again be presented a main web page containing management options (step 260). Those skilled in the art will appreciate that the invention may employ additional set-up and maintenance steps without departing from the spirit of the invention.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

As will be appreciated by one of ordinary skill in the art, system 100 may be embodied as a customization of an existing system, an add-on product, upgraded software, a stand alone system (e.g., kiosk), a distributed system, a method, a data processing system, a device for data processing, and/or a computer program product. Accordingly, system 100 may take the form of an entirely software embodiment, an entirely hardware embodiment, or an embodiment combining aspects of both software and hardware. Furthermore, system 100 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

System 100 may include any number of databases comprising hardware and/or software suitably configured to facilitate storing authentication and/or privilege information relating to users, security, privileges, products, reporting hierarchies, report recipients, billing information, contacts as well as any other information disclosed herein. One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Washington), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the highlevel class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional embodiments of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

System 100 may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and system 100 includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above.

What is claimed is:

1. A computer-implemented method for creating reporting hierarchies, said method including:
defining a reporting organization;
defining a reporting group, wherein said reporting group includes a portion of said reporting organization;
associating said reporting group with said reporting organization;
associating a user with said reporting group; and
determining at least one of said reporting organization and said reporting group which is authorized to receive a report, wherein said report is configured to be accessed by said user.

2. The method of claim 1, further including linking at least two reporting groups into an entity.

3. The method of claim 1, further including at least one of setting a delivery mode, setting a hold indicator, setting a sort criteria, choosing a report format, and setting a delivery frequency.

4. The method of claim 1, further including delivering said report to at least one of said reporting organization and said reporting group.

5. The method of claim 1, further including maintaining at least one of said reporting organization and said reporting group.

6. The method of claim 1, further including maintaining at least one of said reporting organization and said reporting group by changing at least one of a name, an entity type, and an entity identification.

7. The method of claim 1, wherein said step of defining said reporting group includes said reporting group including a portion of said reporting organization and other members outside of said organization.

8. The method of claim 1, wherein said step of associating said reporting group with said reporting organization includes said reporting group having a first key field and said reporting organization having a second key field, and associating said first and second key fields.

9. The method of claim 1, wherein said step of defining a reporting organization includes searching for said reporting organization based upon at least one of an organization identification and organization name.

10. The method of claim 1, wherein said step of defining a reporting group includes searching for said reporting group based upon at least one of a group identification and group name.

11. The method of claim 1, wherein said step of associating a user includes searching for said user based upon at least one of a user identification, user name, and user email address.

12. The method of claim 1, further including linking at least two reporting groups into an entity and delivering a report to said entity.

13. A machine-readable medium having stored thereon a plurality of instructions, said plurality of instructions when executed by a processor, cause said processor to perform a method comprising the step of:
defining a reporting organization;
defining a reporting group, wherein said reporting group includes a portion of said reporting organization;
associating said reporting group with said reporting organization;
associating a user with said reporting group; and
determining at least one of said reporting organization and said reporting group which is authorized to receive a report, wherein said report is configured to be accessed by said user.
